(19) United States
(12) Patent Application Publication
(10) Pub. No.: US 2003/0042084 A1
(43) Pub. Date: Mar. 6, 2003

(54) Brake device having electric type brake mechanism

(75) Inventors: Kazuo Kawase, Tokyo (JP); Masaaki Tanaka, Tokyo (JP); Kimio Takahashi, Tokyo (JP); Yoshihiko Suzuki, Tokyo (JP); Kazuhiro Sekiguchi, Tokyo (JP)

Correspondence Address: MORGAN LEWIS & BOCKIUS LLP, 1111 PENNSYLVANIA AVENUE NW, WASHINGTON, DC, 20004, US

(73) Assignee: Akebono Brake Industry Co., Ltd.

(21) Appl. No.: 10/229,140

(22) Filed: Aug. 28, 2002

(30) Foreign Application Priority Data
Aug. 29, 2001 (JP) P2001-258970

(51) Int. Cl. F16D 55/08

(52) U.S. Cl. 188/72.1

(57) ABSTRACT

A brake device provided with a hydraulic type brake mechanism in which a piston operated by hydraulic pressure can press a friction member to a rotatable member and an electric type brake mechanism capable of pressing the friction member to the rotatable member by operation of the piston by an electric motor. Further, the brake device includes a force converting mechanism provided at the inside of the piston for converting rotation of an operating shaft connected to the electric motor into movement of the piston in an axial direction of the rotatable member, and a drive portion of the electric brake mechanism having the electric motor and an elastic member arranged substantially coaxially between a pair of opposed rotating members for transmitting rotational force of the electric motor and the operating shaft is connected attachably to and detachably from one of the rotating members.

### BACKGROUND OF THE INVENTION

1. Field of the Invention

The present invention relates to a brake device integrating an electric type brake mechanism to a hydraulic type brake mechanism for carrying out braking control by controlling hydraulic pressure at the inside of a wheel cylinder, particularly relates to a brake device facilitating integration of a hydraulic type brake mechanism and an electric type brake mechanism, preventing detachment of parts from the respective mechanisms in integrating the respective mechanisms, further, facilitating shaft core alignment in integrating the two mechanisms.

2. Description of the Related Art

There is known a disc brake device integrating a parking brake to a hydraulic type brake in Japanese Patent Examined Publication Sho. 55-14296 or the like.

The disc brake device is constructed by a constitution in which a parking brake mechanism is integrated to a piston axis core of a hydraulic type brake in an aligned state and a piston in the hydraulic type brake mechanism is moved by operating the parking brake to thereby achieve brake force.

Further, there is also known an electric type brake device operating an electric motor by an electric signal and pressing a friction member (brake pad) to a rotatable member (brake rotor) to thereby generate brake force (for example, Japanese Patent Unexamined Publication No. 2000-110860).

However, according to the above-described brake device, a structure of integrating the hydraulic type brake and the parking brake, or a structure for attaching an electric mechanism is complicated and promotion of the operational efficiency is requested.

### SUMMARY OF THE INVENTION

Hence, it is an object of the invention to resolve the above-described problem by providing a brake device capable of easily integrating a hydraulic type brake mechanism and an electric type brake mechanism.

According to the invention, in dividing the hydraulic brake mechanism and the electric brake mechanism in two and integrating the electric type brake mechanism to the hydraulic type brake mechanism, even when there is more or less misalignment or integration error, the two members can firmly be integrated by operation of an elastic member interposed therebetween. Further, by adopting a force converting mechanism and a brake clearance adjusting mechanism in the hydraulic type brake mechanism, a friction member (brake pad) can swiftly be moved at an initial stage of operating an electric brake and after operating the brake, high tightening force can be achieved. Further, even when the brake pad is brought into a worn state, always constant brake clearance can be achieved.

Therefore, technical resolving means adopted by the invention is a brake device provided with a hydraulic type brake mechanism in which a piston 3 operated by hydraulic pressure can press a friction member P to a rotatable member D and an electric type brake mechanism capable of pressing the friction member P to the rotatable member D by operation of the piston by an electric motor 34 of the piston. The brake device is characterized by including a force converting mechanism 11, 12, or 8 for converting rotation of an operating shaft 10 connected to the electric motor 34 into movement of the piston 3 in an axial direction at the rotatable member D at inside of the piston 3, and a drive portion of the electric type brake mechanism having the electric motor 34 and an elastic member 36 arranged substantially coaxially between a pair of opposed rotating members 32 and 30 for transmitting rotational force of the electric motor 34 in which the operating shaft 10 is connected attachably to and detachably from one of the rotating members.

Further, the technical resolving means is the brake device characterized in that the force converting mechanism is a ball ramp mechanism including a nut screwed to the operating shaft, a ramp body slidably fitted to the operating shaft and unrotatably and slidably provided at the piston, and a rotating member arranged between the nut and the ramp body. In the ball ramp mechanism, the nut, the ramp body and the rotating member can tackedly be integrated.

Further, the technical resolving means is the brake device characterized in that the force converting mechanism is a ball ramp mechanism including a nut screwed to the operating shaft, a ramp body slidably fitted to the operating shaft and attached to the piston by way of a one-way clutch, and a rotating member arranged between the nut and the ramp body.

Further, the technical resolving means is the brake is device characterized in that two sets of the force converting mechanism are arranged in series on the operating shaft.

Further, the technical resolving means is the brake device characterized in that when the elastic member 36 is deformed by a predetermined amount or more by operating the electric motor, the pair of rotating members are brought into direct contact with each other to transmit the rotational force.

Further, the technical resolving means is a brake device including: a hydraulic type brake mechanism in which a piston 3 operated by a hydraulic pressure can press a friction member P to a rotatable member D, and an electric type brake mechanism capable of pressing the friction member P to the rotatable member D by operation of the piston 3 by an electric motor 34. The brake device further comprises a nut member 41 screwed to an operating shaft 42 rotated by rotation of the electric motor 34 and attached to the piston 3 by way of a one-way clutch, and a force converting mechanism 40a, 46, 47 for moving a drive shaft 40 connected to the operating shaft 42 to the rotatable member D, characterized in that the drive shaft 40 is attached with the electric type brake mechanism including a gear mechanism 32, 33 for transmitting a rotational force from the electric motor 34, an elastic member 36 arranged at inside of the gear mechanism and a torque plate 30 attached to the elastic member 36 connectably to be attachably thereto and detachably therefrom.

Further, the technical resolving means is the brake device characterized in that the electric type brake mechanism including the electric motor, a gear mechanism for transmitting the rotational force from the electric motor, an elastic member arranged between the gear mechanism and the torque plate, and a gear coupled to the torque plate and connectable to a gear provided at the drive shaft at an end portion thereof, the gear is made connectable attachably to and detachably from the gear on the drive shaft.

Further, the technical resolving means is the brake device characterized in that either of the operating shaft and the drive shaft including a mechanism of detecting a rotational position as brake clearance adjusting means and an electric pickup sensor thereof is provided to a member 31 attachable to and detachable from a caliper.

### BRIEF DESCRIPTION OF THE DRAWINGS

FIG. 1 is a sectional view (including a section taken along a line II-II in FIG. 2) of a brake device according to a first embodiment of the invention.

FIG. 2 is a sectional view taken along a line I-I in FIG. 1.

FIG. 3 illustrates a side view and a front view of rotating members (gear, torque plate) constituting FIG. 2 and an elastic member provided therebetween.

FIG. 4 is a sectional view taken along a line III-III in FIG. 1.

FIG. 5 illustrates enlarge front view and sectional view of a ramp body and a nut portion in FIG. 1.

FIG. 6 illustrates views showing other example in correspondence with FIG. 5.

FIG. 7 is an explanatory view of a ball ramp mechanism.

FIGS. 8(a) and 8(b) illustrate a front view and a sectional view for explaining an example of making the ball ramp mechanism in two stages.

FIG. 9 is a sectional view according to a second embodiment of the invention.

### DETAILED DESCRIPTION OF THE PREFERRED EMBODIMENTS

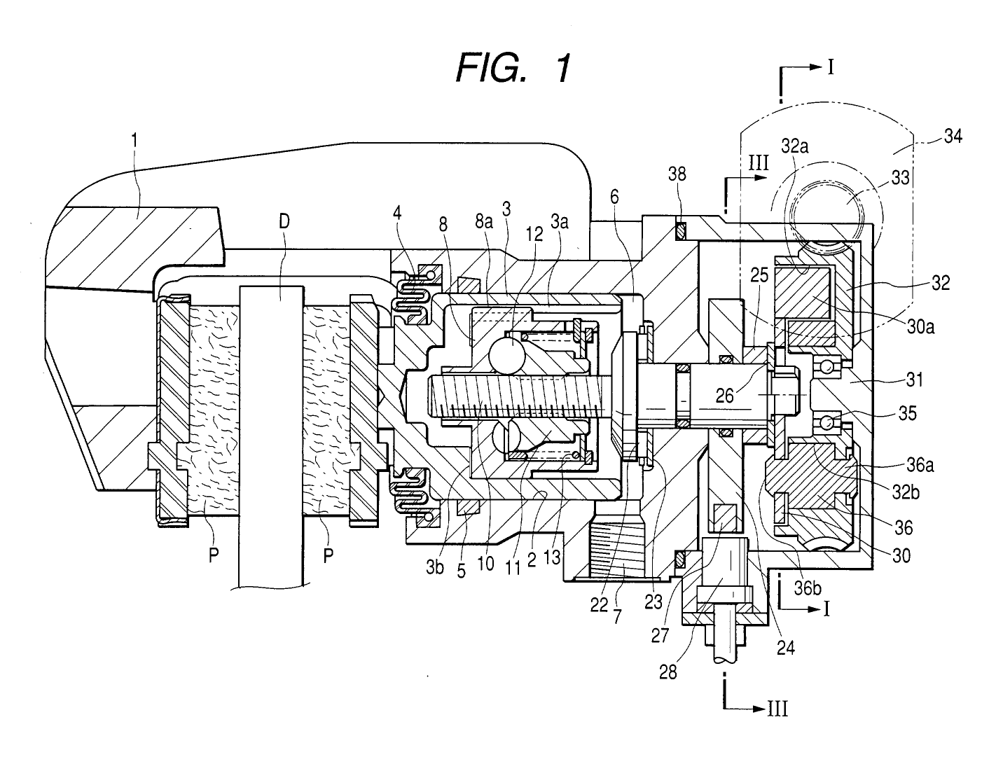

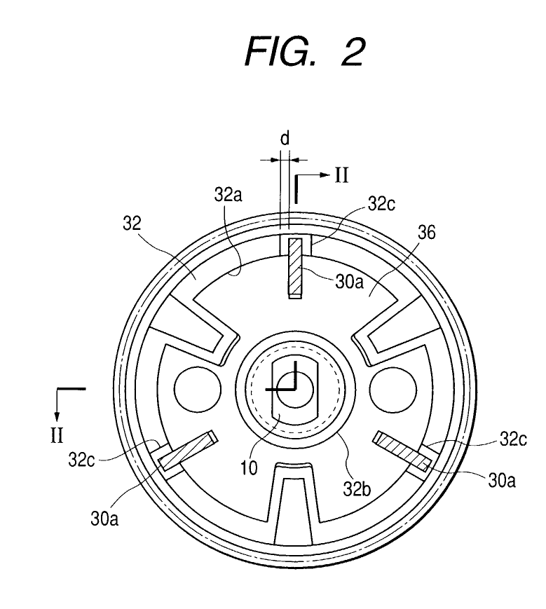

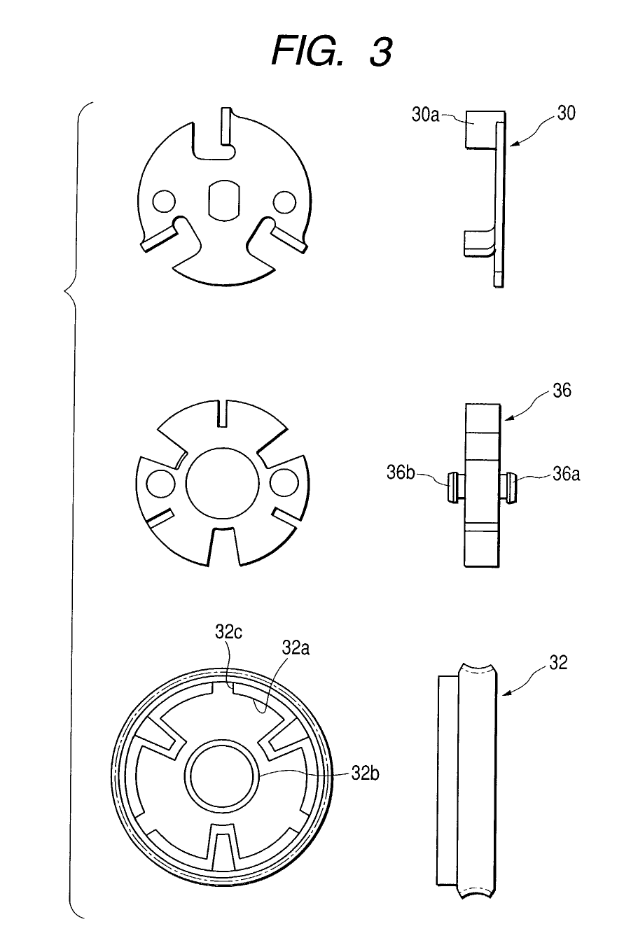

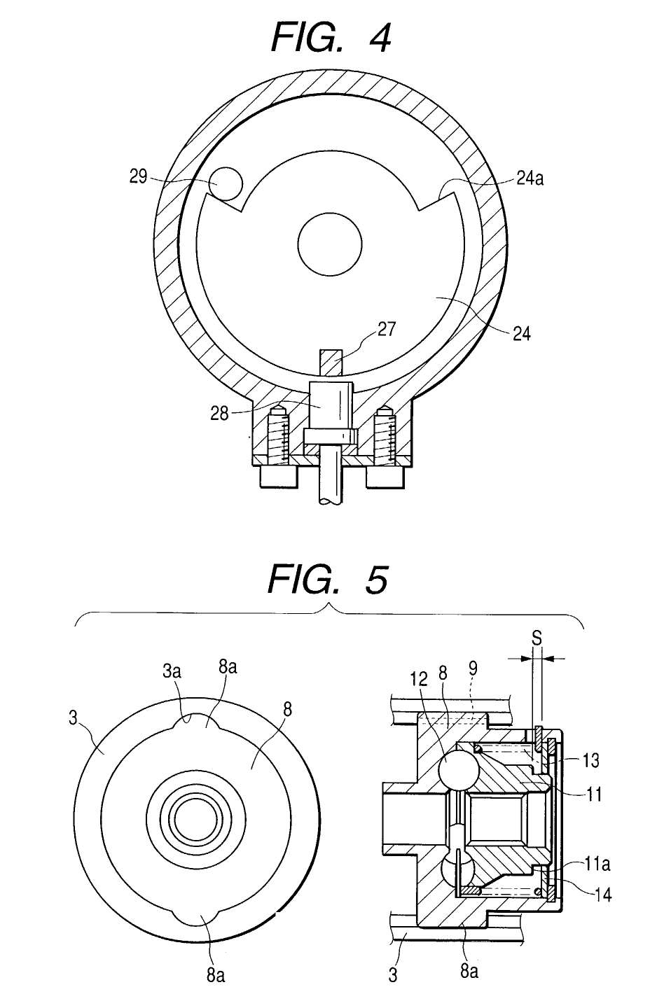

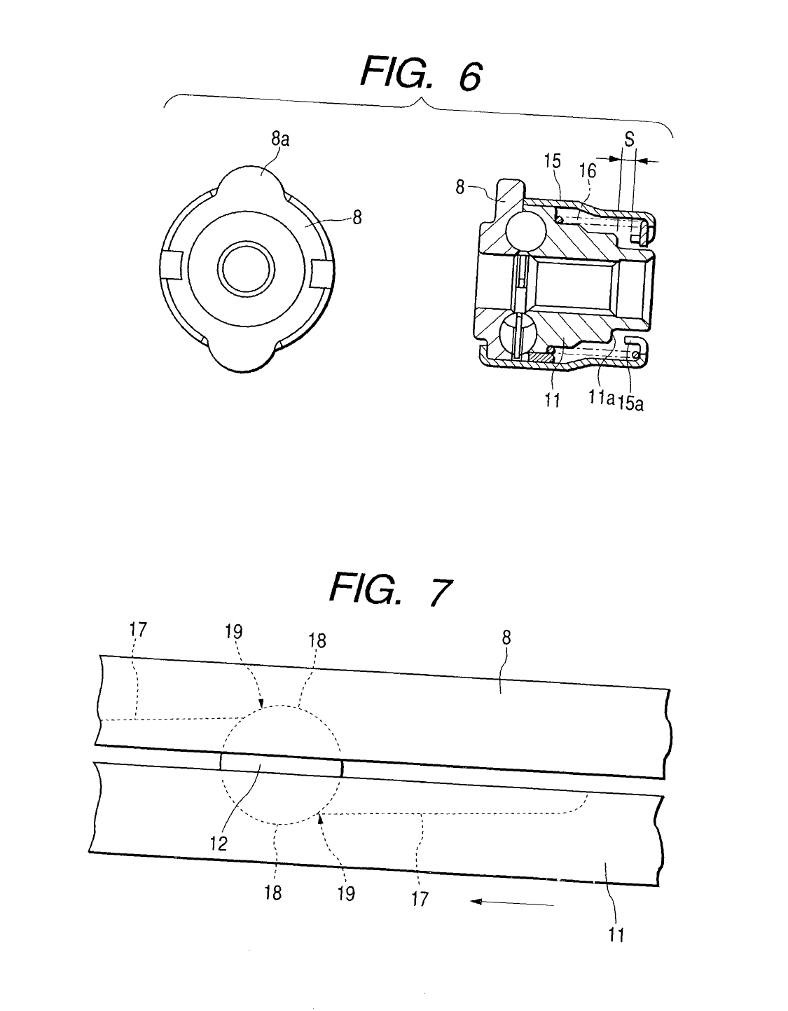

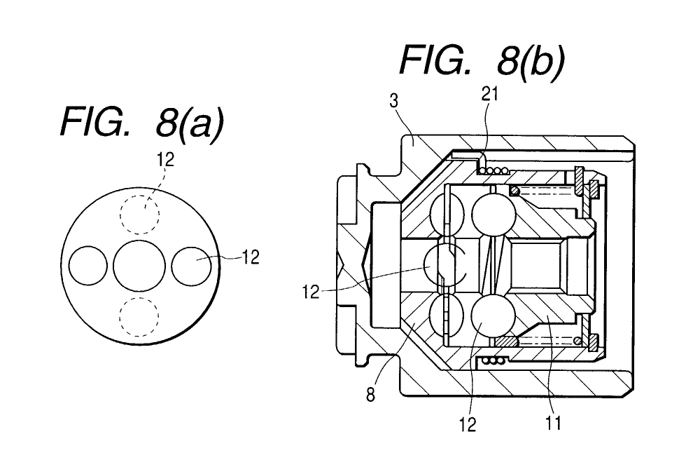

Explaining a mode for carrying out the invention in reference to the drawings as follows, FIG. 1 is a sectional view including a section taken along a line II-II in FIG. 2 of a brake device in a state of integrating a hydraulic type brake mechanism and an electric type brake mechanism according to the embodiment. FIG. 2 is a sectional view taken along a line I-I in FIG. 1. FIG. 3 illustrates a side view and a front view of constituent members (rotating members: gear, torque plate) and an elastic member provided therebetween. FIG. 4 is a constitution view (sectional view taken along a line III-III in FIG. 1) of a brake clearance adjusting mechanism for maintaining a brake clearance constant. FIG. 5 illustrates enlarged front view and sectional view of a ramp body and a nut in FIG. 1. FIG. 6 is a view showing other example in correspondence with FIG. 5. FIG. 7 is an explanatory view of a ball ramp mechanism. FIGS. 8(a) and 8(b) respectively illustrate a front view and a sectional view for explaining still other example constituting two stages of a ball ramp mechanism.

In FIG. 1, as is publicly known, the brake device is constructed by a constitution in which a caliper 1 is provided, there is provided a brake pad P constituting a friction member opposed to a brake rotor D constituting a rotatable member between a claw portion of the caliper 1 and a piston 3, by moving the brake pads in an axial direction of the brake rotor D, the brake rotor D constituting the rotatable member is held and brake force can be operated. The piston 3 is slidably arranged at inside of a cylinder 2 formed at inside of the caliper 1, a dust seal 4 and a hydraulic seal 5 are arranged between the piston 3 and cylinder 2 and the hydraulic seal 5 serves also as a returning spring for returning the piston 3 to a regressed position after operating the hydraulic type brake. The piston 3 is formed with a hydraulic chamber 6 at a central portion thereof and the hydraulic chamber 6 is connected to a master cylinder, not illustrated, via a hole 7 formed at the caliper 1. The basic constitution of the above-described brake device is similar to that of a conventional brake device.

Further, there is arranged a ramp body 8 constituted by a shape shown in FIG. 1 and FIG. 5 constituting a force converting mechanism at inside of the hydraulic chamber of the piston 3. The ramp body 8 is provided with a projected portion 8a at a surrounding thereof and by fitting the projected portion 8a to a recessed portion 3a formed at an inner face of the piston 3 in the axial direction, and there is constructed a constitution which is nonrotational and slidable in the axial direction at inside of the piston 3. Further, the ramp body 8 is formed with a flow path 9 for communicating the hydraulic chamber on the side of the above-described hole 7 formed at the above-described caliper 1 and the hydraulic chamber on the side of an end portion of the piston. Further, for the nonrotational and slidable integrating structure of the ramp body 8 and the piston 3, other integrating structure capable of achieving a similar function can be adopted.

An operating shaft 10 is rotatably and slidably held at a center of the ramp body 8, further, a nut 11 screwed to the operating shaft 10 is arranged at inside of the ramp body 8 and a rotating member (ball) 12 forming a ball ramp mechanism is arranged between the ramp body 8 and the nut 11. The force converting mechanism is constituted by the ramp body 8, the nut 11 and the ball 12. The nut 11 at inside of the ball ramp mechanism holds the ball 12 along with the ramp body 8 by being always urged in the left direction movably by a coil spring 13. Further, the right side of the nut 11 in the drawing, is formed with a stepped portion 11a (see FIG. 5) for preventing the nut 11 from overreturning, and a washer 14 is attached at an end portion of the ramp body 8 opposedly to the stepped portion 11a. By bringing the stepped portion 11a of the nut 11 into contact with the washer 14, the nut 11 is prevented from further moving (overreturning) in the right direction in the drawing. Further, as a constitution for preventing the nut 11 from overreturning, it is also possible to prevent the nut 11 from overreturning by using a spring seat 15 fixed to the side of the ramp body 8 as shown by FIG. 6, constituting a portion in contact with the stepped portion 11a of the nut 11 by a foldingly bent end portion 15a formed by folding to bend the spring seat 15 and bringing the stepped portion 11a into contact with the foldingly bent end portion 15a.

As shown by FIG. 7, the force converting mechanism (ball ramp mechanism) is constituted by providing the ramp body 8 and the nut 11 arranged opposedly thereto, inclined grooves 17 formed opposedly to respective opposed faces of the ramp body 8 and the nut 11, and the ball 12 constituting the rotating member held between the two inclined grooves. As shown by FIG. 7, the inclined grooves 17 are formed such that respective groove depths are gradually shallowed when the ramp body 8 and the nut 11 are rotated relative to each other from initial positions thereof, further, there are formed recessed portions 18 for folding the ball at deepest portions of the respective grooves 17, and at contact points 19 in contact with the recessed portions 18 and the inclined grooves 17 are formed with stepped portions which the ball can ride over when predetermined forces are operated. Further, the balls 12 are held between the opposed inclined grooves and take an initial state shown in FIG. 7. Further, although three pieces of the ball ramp mechanisms are arranged at equal intervals between the ramp body 8 and the nut 11, in order to exert larger force transmission force, as shown by FIGS. 8(a) and 8(b), two sets of the ball ramp mechanisms can be arranged in series in the axial direction. In this case, by shifting positions of the rotating members (balls) of the first set of the ball ramp mechanisms and the second set of the ball ramp mechanisms as shown by FIG. 8(a), offset load by the ball ramp mechanisms can be prevented. Further, instead of the ball in the force converting mechanism, a rotating member in cylindrical shape can also be used.

Although the ramp body 8 constituting the ball ramp mechanism can be constituted by the mechanism of preventing rotation of the ramp body 8 by the recessed portion 3a formed at the inner face of the piston 3 as described above, as shown by FIG. 8(b), a one-way clutch can also be used. Although various mechanisms can be adopted for the one-way clutch, according to the example, the one-way clutch is constituted by a coil spring 21 wound at a surrounding of the ramp body 8 and the coil spring 21 is constructed by a constitution in which one end thereof is inserted into the groove of the piston 3 to thereby make the coil spring 21 movable in the axial direction of the brake rotor D and unrotatable. The other end thereof is constituted by the ring-like shape having a diameter smaller than a diameter of the ramp body 8 and is wound at an outer periphery of the ramp body 8. According to the one-way clutch, in operating a brake, the coil spring 21 is fastened and the surrounding of the ramp body 8 is fastened to thereby prevent relative rotation between the ramp body 8 and piston 3. Further, when excessive force is operated to the ramp body 8 in releasing the brake, the coil spring 21 is loosened and there is not present also a force fastening the surrounding of the ramp body 8 and there is brought about a state in which the ramp body 8 is rotatable relative to the piston 3.

The operating shaft 10 is axially supported by a thrust bearing 22 relative to the caliper 1 and a reinforcement plate 23 for preventing wear of the caliper made of aluminum is provided between the thrust bearing 22 and the caliper 1. Further, a rotor 24 constituting a mechanism of detecting a rotational position as a brake clearance adjusting means for maintaining a brake clearance constant, is arranged at a portion projected to an outer side of the caliper 1. The rotor 24 is held by the operating shaft 10 by a spacer 25 and a stop ring 26 on the operating shaft 10, further, the rotor 24 is constituted by a front shape shown in FIG. 4 and is held by the rotating shaft 10 such that in a state in which load is not applied to the rotor 24, the rotor 24 is rotated integrally with the operating shaft 10. When a stepped portion 24a is brought into contact with a stopper 29, the rotor 24 can be rotated on the operating shaft 10 by sliding on the shaft. The stepped portion 24a of the rotor 24 is for restricting a rotational amount of the rotor 24 by being brought into contact with the stopper 29, a magnet 27 for adjusting the brake clearance is attached to a middle between the stepped portions and an electric pickup sensor 28 for detecting a position of the magnet 28 is attached to a side of a casing 31 attachable to and detachable from the caliper.

At an end portion of the operating shaft 10 on a further outer side of the stop ring 26 for holding the rotor 24 along with the collar 25, there is formed a coupling portion including a parallel face for coupling a torque plate (details of which will be described later) 30 on a side of an electric type brake mechanism in an unrotational state as shown by FIG. 2. Further, on a side of the hydraulic type brake, there is constituted an integrated product integrated with constituent parts up to the rotor 24, the hydraulic type brake mechanism is constituted by these and the electric type brake mechanism, mentioned later, can simply be attached to the hydraulic type brake mechanism.

The electric type brake mechanism is provided with the casing 31 and an electric motor 34 fixed to the casing 31, and a gear 32 is axially supported rotatably by a bearing 35 at inside of the casing 31. The gear 32 and a worm gear 33, which are attached to an output shaft on a side of the electric motor 34, are brought in mesh with each other, a speed reducing gear mechanism and a lock mechanism for maintaining brake force are constituted by these. Further, the gear 32 constitutes a rotating member along with the torque plate 30, mentioned later, and the each of them is constructed by the following constitutions.

As shown by FIG. 2 and FIG. 3, according to the gear 32 constituting a rotating member, an elastic member 36, three portions of which are notched, is substantially coaxially fitted and attached to inside of a recessed portion 32a formed on a side of the gear 32 and having a shape substantially the same as the elastic member 36 and the elastic member 36 is fixed to a boss portion 32b of the gear 32 at a central portion thereof. Further, projections 36a and 36b projected in the axial direction as shown by FIG. 3, are formed at two faces of the elastic member 36, the projection 36a on the right side in the drawing, is fitted to a hole formed at the gear 32 and the projection 36b on the other side is fitted to the torque plate 30 arranged concentrically with the gear to thereby be integrated such that respective parts are prevented from detaching.

The torque plate 30 constituting a rotating member, is provided with a foldingly bent portion 30a foldingly bent to the side of the gear 32 and the foldingly bent portion 30a is inserted into a notch 32c formed on the side of the gear 32. As shown by FIG. 2, the notch 32c is formed to be larger than a plate thickness of the foldingly bent portion of the torque plate 30, and is constructed by a constitution in which when the elastic member is deformed by a predetermined amount (gap “d”) or more by rotating the gear 32, the foldingly bent portion 30a and the gear 32 are directly coupled with each other and rotation of the gear 32 is directly transmitted to the torque plate 30. A central portion of the torque plate 30 is formed with a fitting hole capable of fitting the coupling portion having the parallel face of the operating shaft 10 of the side of the hydraulic type brake mechanism. Further, the casing 31 is attached with the stopper 29 which is brought into contact with the stepped portion of the rotor 24 and the by rotating the rotor 24 from the position in FIG. 4 in the left direction of the drawing and bringing the stepped portion 24a into contact with the stopper 29, further rotation of the rotor 24 can be restricted.

An explanation will be given of integrating operation and operation of the brake device including the above-described constitution.

As described above, the hydraulic type brake mechanism is constituted by a mechanism integrated as far as the rotor 24 constituting the brake clearance adjusting means attached to the operating shaft 10, further, the electric type brake mechanism is constituted by a mechanism integrated with from the electric motor 34 up to the torque plate 30. Therefore, in order to integrate the two mechanisms, the two members can simply be integrated by fitting the torque plate 30 of the electric type brake mechanism to the coupling portion of the operating shaft 10 of the hydraulic type brake mechanism. Even when there is present more or less deviation between axis cores of the two members in integrating the two members, the two members can firmly be integrated by operation of the elastic member 36, further, play in integrating the two members can also be absorbed by the elastic member 36. Further, a seal member 38 is arranged at faces of the casing 31 and the caliper 1 in contact with each other and the casing 31 is fixed to the side of the caliper 1 by pertinent means. Further, in such an integrating operation, parts constituting the respective mechanisms are fixed to insides of the respective mechanisms to prevent from being detached and therefore, parts are not detached in integrating the two members.

An explanation will be given of operation of the brake device shown in FIG. 1.

In operating the hydraulic type brake (service brake):

In operating the hydraulic type brake, by operating to push a brake pedal, hydraulic pressure produced at a master cylinder, not illustrated, flows into the hydraulic chamber 6 formed at inside of the caliper, by the hydraulic pressure, the piston 3 is moved in the left direction of the drawing while bending the seal member 5 and presses the friction member (brake pad) to the rotatable member (brake rotor) to thereby operate the brake. Further, in releasing the brake, the piston 3 returns to the initial state by the returning operation of the seal member 5.

In operating the electric type brake (parking brake):

When a switch of the electric type brake is operated to an operating side for operating the electric type brake, the electric motor 34 is operated and the operating shaft 10 is rotated via the worm gear 33, the gear 32, the elastic member 36 and the torque plate 30. When the elastic member 36 is deformed by a predetermined amount or more, the foldingly bent portion 30a on the side of the torque plate 30 and the gear 32 are directly coupled with each other and rotation of the gear 32 is directly transmitted to the torque plate 30. At an initial state of operating the brake, the brake clearance between the brake pad and the brake rotor is not nullified, press force between the ramp body 8 and the nut 11 is small and therefore, in a state of bringing the ball ramp mechanism into an unoperated state, the ramp body 8 and the nut 11 are integrally moved on the operating shaft 10 in the left direction of the drawing. By the movement, the ramp body 8 is brought into contact with the stopper 3b formed at the inner face of the piston 3, the piston 3 is moved in the left direction of the drawing to thereby move the brake pad and press the pad to the brake rotor. Further, by reactive force at this occasion, the caliper 1 is moved in the right direction, the brake pad on the other side is also pressed to the brake rotor and brake is operated by the two brake pads. In operating the brake, the rotor 24 for adjusting the brake clearance is also rotated along with the operating shaft 10 and when the brake pad is worn, rotation of the rotor 24 is restricted by the stopper 29, slip is produced between the rotor 24 and the operating shaft and the rotor 24 is prevented from rotating by a predetermined rotational angle or more.

When the brake pressing force is further increased, that is, when press force from the ramp body 8 to the nut of the force converting mechanism (ball ramp mechanism) is increased, the nut 11 starts rotating integrally with the operating shaft 10, by rotating the nut 11, the ball ramp mechanism is operated, the ramp body 8 in the unrotational state is moved in the left direction of the drawing and higher brake pressure can be achieved. When the ramp body 8 is moved by a predetermined distance, the washer 14 provided on the side of the ramp body 8 is brought into contact with the nut 11 to thereby prevent a situation of jumping out the ball 12 from a groove of the ball ramp mechanism. In the state of operating the brake, when the electric motor is stopped, the state is maintained by a lock mechanism including the worm gear.

When the switch of the electric type brake is operated to a releasing side, the electric motor 34 is rotated reversely to thereby reversely rotate the torque plate 30. In releasing the brake, rolling resistance of the ball 12 is smaller than friction resistance between the operating shaft 10 and the nut 11 and therefore, first, the ball ramp mechanism returns to the initial state to thereby reduce the brake force, thereafter, the nut 11 is moved in the unrotational state on the operating shaft in the right direction of the drawing and by the movement, the ramp body 8 is moved in the right direction of the drawing integrally therewith to thereby release the brake. Further, when the magnet 27 of the rotor 24 for adjusting the brake clearance is returned to the position of the sensor 28, the electric motor 34 is stopped, thereby, the brake clearance can always be made constant regardless of a wear amount of the part. That is, even in a state in which the brake pad is worn, after operating the brake, when the brake is released, the electric motor 2 is rotated reversely and the magnet 27 attached to the rotor 24 returns to the position of the sensor 28, the electric motor 34 is stopped, thereby, the always constant brake clearance can be provided regardless of the worn state of the brake pad.

Further, although according to the embodiment, the brake clearance after releasing the brake pedal can be maintained in the proper state by the ball ramp mechanism and the switch mechanism as mentioned above, a switch mechanism for adjusting the brake clearance can be omitted as necessary.

An explanation will successively be given of a second embodiment according to the invention.

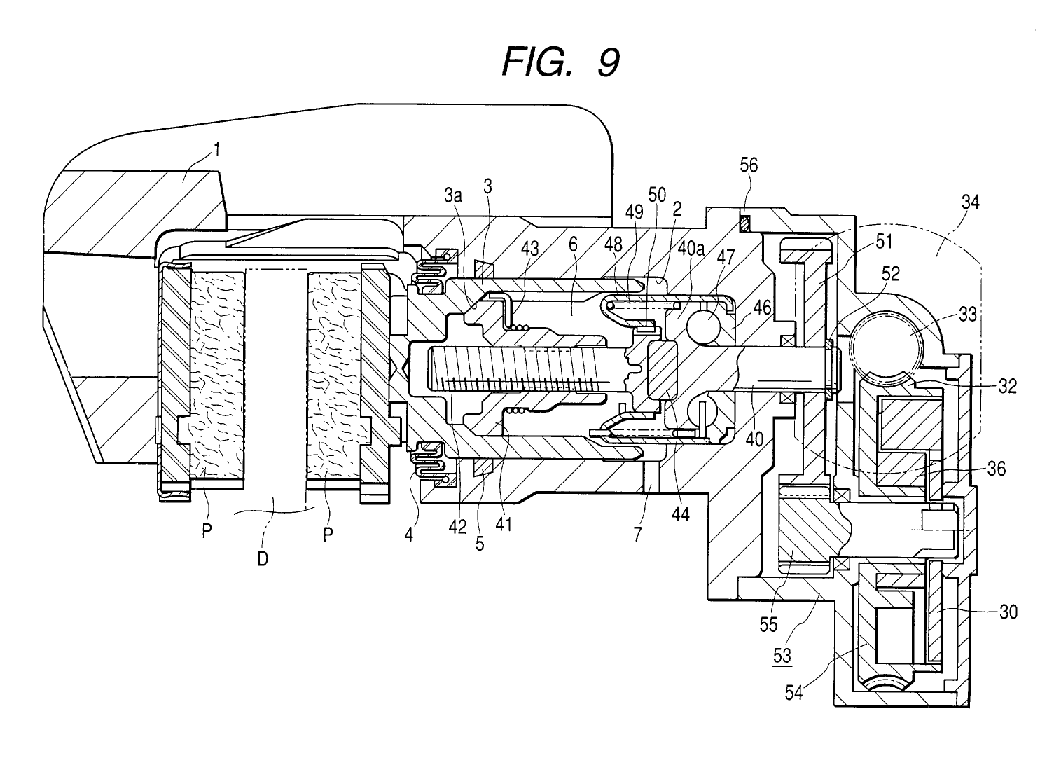

FIG. 9 is a sectional view of a brake device having an electric type brake mechanism according to the second embodiment and according to the second embodiment, a hydraulic type brake mechanism is constructed by a constitution the same as that of the first embodiment in basic portions thereof. Further, notations the same as those in the first embodiment designate the same members.

In FIG. 9, the brake device is provided with the caliper 1, at inside of the cylinder 2 formed at inside of the caliper 1, the piston 3 is slidably arranged and the hydraulic chamber 6 is formed and the hydraulic chamber 6 is connected to a master cylinder via the hole 7 formed at the caliper 1. Constitutions of these are similar to those in the first embodiment.

Further, at inside of the piston 3, a nut 41 is arranged unrotatably and slidably and the center of the nut 41 is screwed with an operating shaft 42. A coil spring 43 similar to the one-way clutch(see FIGS. 8(a) and 8(b)), mentioned above, is provided at a surrounding of the nut 41. An end portion of the operating shaft 42 on a side opposed to the brake pad is connected to a drive shaft 40 via a thrust bearing 44 and the drive shaft 40 is integrally formed with a ramp body 40a constituting a force converting mechanism (ball ramp mechanism). The ball ramp mechanism is similar to that of the first embodiment and a ramp member 46 is attached rotatably relative to the brake shaft 40 opposedly to the ramp body 40a and a ball 47 is arranged between the ramp body 40a and the ramp member 46. One end of a casing 48 is fixed to the ramp member 46, other end thereof is folded to bend to serve also as a spring seat and is fixed to a side of the operating shaft 42 (50) and a spring 49 for urging the ramp body 40a to the ramp member 46, is arranged between the casing 48 and the ramp body 40a.

The drive shaft 40 is axially supported by the caliper 1 and an end portion thereof projected from the caliper 1 to an outer side, is attached with a gear 51 by a stop ring 52. Further, constituent parts up to the gear 51 are defined as parts on a side of the hydraulic type brake mechanism and the hydraulic type brake mechanism can be attached with an electric type brake mechanism, mentioned later.

The electric type brake mechanism is provided with a case 53 fixed with the electric motor 34 for driving, at inside of the case 53, a gear 54 is axially supported rotatably by a bearing, the gear 54 and the worm gear 33 attached to the output shaft on the side of the electric motor 34 are brought into mesh with each other to thereby constitute a gear mechanism. The torque plate 30 is attached to the gear 54 via a mechanism similar to that of the first embodiment and a gear 55 in mesh with the gear 51, mentioned above, is attached to a shaft end fixed to the electric motor 30. Further, the constituent parts from the electric motor 34 up to the gear 55 are defined as parts on a side of the electric type brake mechanism and can be attached to the side of the hydraulic type brake mechanism.

An explanation will be given of integrating operation and operation of the brake device including the above-described constitution.

As mentioned above, the hydraulic type brake mechanism is constituted by a mechanism integrated with up to the gear 51 attached to the drive shaft 40, further, the electric type brake mechanism is constituted by a mechanism integrated with from the electric motor 34 up to the gear 55 and therefore, by bringing the gear 51 of the hydraulic type brake mechanism into mesh with the gear 55 on the side of the electric type brake mechanism, the two mechanisms can simply be integrated. Further, faces of the case 53 and the caliper 1 in contact with each other are arranged with a seal member 56. In such an integrating operation, parts constituting the respective mechanisms are fixed in the respective mechanisms to prevent from being detached.

An explanation will be given of operation of the brake as follows.

In operating the hydraulic type brake (service brake):

In operating the hydraulic type brake, by operating to push the brake pedal, hydraulic pressure produced at a master cylinder, not illustrated, flows into the hydraulic chamber 6 formed at the piston 3 and by the hydraulic pressure, the piston 3 is moved in the left direction of the drawing and pushes the brake pad P to the rotor D to thereby operate the brake. Further, in releasing the brake, the piston returns to the initial state by returning operation of the seal member. The operation is similar to that of the first embodiment.

In operating the electric type brake (parking brake):

When the switch of the electric type brake is operated to the operating side for operating the electric type brake, the electric motor 34 is operated, the gear 55 is rotated via the worm gear 33, the gear 54, the elastic member 36 and the torque plate 30 and the gear 51 in mesh with the gear 55 is rotated to thereby rotate the drive shaft 40. At the initial stage of operating the brake, the brake clearance between the brake pad and the rotor is not nullified, the press force between the ramp body 40a and the ramp member 46 is small and therefore, the ball ramp mechanism is brought into the unoperated state. Further, the nut 41 is held by the piston 3 in the unrotational state and therefore, when the operating shaft 10 is rotated, by the screw operation, the nut 41 is moved on the operating shaft 42 in the left direction of the drawing. By the movement, the nut 41 is brought into contact with a stopper 3a formed in a conical shape at an inner face of the piston 3, the piston 3 is also moved in the left direction of the drawing to thereby move the brake pad P and press the pad P to the brake rotor D. Further, by reactive force at this occasion, the caliper 1 is moved in the right direction and the brake pad P on the other side is also pressed by the brake rotor D and the brake is operated by the two brake pads P.

When the brake press force is further increased, the reactive force is transmitted to the drive shaft 40 via a thrust bearing 44 and the ramp body 40a is further pressed to the side of the ramp member 46. When press force from the ramp body 40a to the ball is increased by the pressing operation, the ramp member 46 is brought into the unrotational state, meanwhile, rotational force from the electric motor 34 is transmitted to the ramp body 40a and therefore, the ball ramp mechanism is operated and the piston 3 is moved in the left direction of the drawing via the ramp body 40a, the operating shaft 42 and the nut 41 and higher brake force can be achieved. In the state of operating the brake, when the electric motor is stopped, the state is maintained by the lock mechanism including the worm gear. The electric type brake is frequently used as a parking brake from such reason.

When the switch of electric type brake is operated to the releasing side, the electric motor 34 is rotated reversely. In releasing the brake, rolling resistance of the ball 47 is smaller than friction resistance between the ramp member 46 and the caliper 1 and therefore, first, the ball ramp mechanism returns to the initial state to thereby reduce the brake force, thereafter, the nut 41 is moved on the operating shaft 42 in the unrotational state in the right direction of the drawing and by the movement, the brake is released. At that occasion, when the operating shaft 42 is excessively rotated and is brought into contact with the nut 41, there is produced friction between the piston and an outer face of the nut 41 in a direction of enlarging an inner diameter of the coil spring 43 which is attached unrotatably and slidably. Thereby, the nut 41 is rotated idly to the piston 3 to thereby prevent the operating shaft 42 from biting excessively the side of the nut.

According to the invention, the brake press force is increased by the screw mechanism screwing the nut to the operating shaft at an initial stage of braking and the brake press force is increased by the ball ramp mechanism after producing a determined brake force thereafter. An amount of moving the brake per unit rotational amount of the electric motor, is set to be smaller on the side of the ball ramp mechanism than the side of the screw mechanism. Therefore, at the initial stage of braking, the brake clearance between the brake pad and the brake rotor is swiftly nullified and after the predetermined brake force is produced, the brake pad can be pressed by large press force by the ball ramp mechanism having excellent mechanical efficiency. Further, the mechanism is useful also for downsizing the electric motor.

As has been described in details, according to the invention, the hydraulic type brake mechanism and the electric type brake mechanism are constituted by two divisions and therefore, operation of integrating the brake is facilitated. Further, by providing the elastic member at the portion of connecting the electric type brake mechanism and the hydraulic type brake mechanism, the deviation between the axis cores of the hydraulic type brake mechanism and the electric type brake mechanism can be absorbed, further, play in integrating can be prevented from being brought about. Further, by providing the brake clearance adjusting means, regardless of the wear amount of the brake pad, the always constant brake clearance can be provided. Further, by using the one-way clutch to the nut arranged at inside of the piston, overreturning of the nut in releasing the brake can be prevented. Further, by constituting the ball ramp mechanism by two stages, there can be achieved excellent effects of being capable of constituting the more efficient force converting mechanism and the like.

What is claimed is:

1. A brake device comprising:
a hydraulic type brake mechanism in which a piston operated by a hydraulic pressure presses a friction member to a rotatable member;
an electric type brake mechanism pressing the friction member to the rotatable member by operation of the piston by an electric motor;
a force converting mechanism provided at the inside of the piston for converting rotation of an operating shaft connected to the electric motor into movement of the piston in an axial direction of the rotatable member; and
a drive portion of the electric type brake mechanism including the electric motor and an elastic member arranged substantially coaxially between a pair of opposed rotating members for transmitting a rotational force of the electric motor, said operating shaft being connected attachably to and detachably from one of the rotating members.

2. The brake device according to claim 1,
wherein the force converting mechanism is a ball ramp mechanism comprising:
a nut screwed to the operating shaft;
a ramp body slidably fitted to the operating shaft and unrotatably and slidably provided at the piston; and
a rotating member arranged between the nut and the ramp body,
wherein the nut, the ramp body and the rotating member can tackedly be integrated.

3. The brake device according to claim 1,
wherein the force converting mechanism is a ball ramp mechanism comprising:
a nut screwed to the operating shaft;
a ramp body slidably fitted to the operating shaft and attached to the piston by way of a one-way clutch; and
a rotating member arranged between the nut and the ramp body.

4. The brake device according to claim 2,
wherein two sets of the force converting mechanisms are arranged in series on the operating shaft.

5. The brake device according to claim 3,
wherein two sets of the force converting mechanisms are arranged in series on the operating shaft.

6. The brake device according to claim 1,
wherein when the elastic member is deformed by a predetermined amount or more by operating the electric motor, the pair of rotating members are brought into direct contact with each other to transmit the rotational force.

7. A brake device comprising:
a hydraulic type brake mechanism in which a piston operated by a hydraulic pressure presses a friction member to a rotatable member;
an electric type brake mechanism pressing the friction member to the rotatable member by operation of the piston by an electric motor;
a nut member screwed to an operating shaft rotated by rotation of the electric motor and attached to the piston by way of a one-way clutch; and
a force converting mechanism for moving a drive shaft connected to the operating shaft to the rotatable member,
wherein the drive shaft is attached with the electric type brake mechanism including a gear mechanism for transmitting a rotational force from the electric motor, an elastic member arranged at inside of the gear mechanism and a torque plate attached to the elastic member connectably to be attachably thereto and detachably therefrom.

8. The brake device according to claim 6,
wherein the elastic member is arranged between the gear mechanism and the torque plate, and
wherein a first gear is coupled to the torque plate and connectable to a second gear provided at the drive shaft at an end portion thereof, and
wherein the first gear is made connectable attachably to and detachably from the second gear on the drive shaft.

9. The brake device according to claim 1,
wherein one of the operating shaft and the drive shaft comprises:
a mechanism of detecting a rotational position as a brake clearance adjusting mechanism and an electric pickup sensor is provided to a casing attachable to and detachable from a caliper.

10. The brake device according to claim 7,
wherein one of the operating shaft and the drive shaft comprises:
a mechanism of detecting a rotational position as a brake clearance adjusting mechanism and an electric pickup sensor is provided to a casing attachable to and detachable from a caliper.
